(19) United States
(12) Patent Application Publication
(10) Pub. No.: US 2012/0315353 A1
(43) Pub. Date: Dec. 13, 2012

(54) Breast Milk Collection, Storage, and Feeding System, Method, and Apparatus

(76) Inventors: Steve Becsi, Yorba Linda, CA (US); Keith Rooks, Mission Viejo, CA (US)

(21) Appl. No.: 13/286,924

(22) Filed: Nov. 1, 2011

Related U.S. Application Data
(60) Provisional application No. 61/496,216, filed on Jun. 13, 2011.

(51) Int. Cl. A61J 11/04; B67C 3/28; A23C 9/152; A61J 9/04

(52) U.S. Cl. 426/2; 215/11.5; 141/18; 141/2

(57) ABSTRACT

Breast milk collection, storage, and feeding apparatus comprising a first storage bottle and first and second differently sized feeding bottles, each of the three bottles having a mouth portion of the same diameter and a common external thread structure, and first and second dual port caps each sized and threaded to attach to each of the three bottles, each dual port cap further having a drip port and a draw port, a pressure relief vent formed therein; and a tethered closure plug unit attached thereto, each tethered closure plug unit having first and second tethered plugs shaped and dimensioned to plug or close a respective one of the drip and draw ports. The apparatus may be used in various manners to transfer milk from the storage bottle to a feeding bottle and to thereafter feed an infant by nipple, syringe, or a gravity/bolus technique.

### CROSS REFERENCE TO RELATED APPLICATIONS

This application claims the benefit of and priority to U.S. Provisional Application Ser. No. 61/496,216, filed Jun. 13, 2011, entitled “Breast Milk Collection, Storage, And Feeding System Method, And Apparatus,” the contents of which are incorporated by reference herein in its entirety.

### BACKGROUND

1. Field

This disclosure relates to breast milk collection, storage, and feeding methods and apparatus and more particularly to such methods and apparatus particularly suitable for premature infant feeding procedures.

2. Related Art

Hospitals presently employ special feeding procedures for special care infants such as those that are prematurely born. Among these are enteral feeding procedures where, for example, human breast milk is delivered through an enteral access device into a functioning gastro intestinal (GI) tract. Such procedures require collection, storage, and preparation of breast milk prior to feeding.

### SUMMARY

The following is a summary description of illustrative embodiments of a breast milk storage and feeding system and related methods. It is provided as a preface to assist those skilled in the art to more rapidly assimilate the detailed design discussion which ensues and is not intended in any way to limit the scope of the claims which are appended hereto in order to particularly point out the invention.

According to an illustrative embodiment, a breast milk storage and feeding system is provided comprising first, second and third differently sized bottles, each having a mouth portion of the same diameter and a common external thread structure. First and second dual port caps are additionally provided, each sized and threaded to attach to each of the first, second and third differently sized bottles. Each dual port cap has a drip port and a draw port and a pressure relief vent. A tethered closure plug unit is further attached to each dual port cap, each tethered closure plug unit further having first and second tethered plugs shaped and dimensioned to plug or close a respective one of the drip and draw ports. A fluid transfer tube may further be provided having first and second connector plugs at respective ends thereof, each connector plug being sized to sealably attach to a respective drip port of each the first and second dual port caps.

Apparatus of the system according to the illustrative embodiment may be employed to perform a feeding procedure comprising filling a first storage bottle with breast milk; placing fortifier in a second bottle; applying a first dual port cap to the first bottle and a second dual port cap to the second bottle; and transferring a selected amount of milk from the first bottle to the second bottle by attaching a transfer tube between the drip ports of the first and second bottles and then inverting the storage bottle to cause milk to be transferred to the second bottle. Thereafter, a patient may be fed by applying a nipple to the second bottle and directly feeding the patient, or by inserting a syringe into the draw port of the second bottle and thereafter employing the syringe to feed the patient. Apparatus of the illustrative system may also be used to perform an alternate feeding procedure wherein the patient is fed by utilizing the drip port of the second dual port bottle in a gravity/bolus feeding process.

### DRAWINGS

FIG. 1 is a perspective view of components of an illustrative breast milk storage and feeding system;

FIG. 2 is a side view of three bottles employed in the system of FIG. 1;

FIG. 3 is a top perspective view of a dual port cap component of the system of FIG. 1;

FIG. 4 is a side view of the cap of FIG. 3;

FIG. 5 is a top view of the cap of FIG. 3;

FIG. 6 is a sectional view taken at VI-VI of FIG. 5;

FIG. 7 is a sectional view taken at VII-VII of FIG. 5;

FIG. 8 is an enlarged view of the fragment VIII of FIG. 7;

FIG. 9 is a perspective exploded view of a dual port cap assembly according to an illustrative embodiment;

FIG. 10 is a top view of a tethered plug unit of FIG. 9;

FIG. 11 is a side sectional view of the tethered plug unit of the assembly of FIG. 9;

FIG. 12 is a perspective view of a vent component of the assembly of FIG. 9;

FIG. 13 is a sectional view of the vent component of FIG. 12;

FIG. 14 is a perspective view showing components of FIG. 1 being used to transfer breast milk from a storage bottle to a feeding bottle;

FIG. 15 is a perspective view illustrating the employment of a syringe to withdraw milk from a dual port capped bottle according to an illustrative embodiment; and

FIG. 16 is a perspective view illustrating a gravity/bolus feeding procedure employing components of the system of FIG. 1.

### DETAILED DESCRIPTION

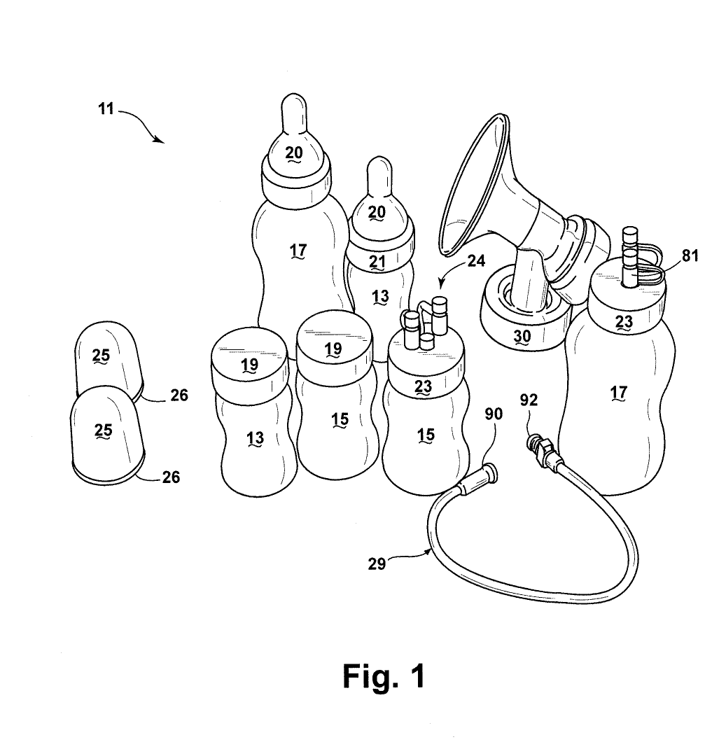

The components of an illustrative breast milk storage feeding system 11 are shown in FIG. 1. The illustrative system 11 includes three bottles: a 1 oz. bottle 13, a 2 oz. bottle 15, and a 5 oz. bottle 17. The system further includes four caps: a solid storage twist cap 19, an open top nipple twist cap 21, a dust cover dome cap 25, and a dual port “drip/draw” vented twist cap 23 with a tethered closure plug unit 24. The system 11 further includes a low volume nipple 27 and a female-to-female connector fluid transfer tube 29. Also shown in FIG. 1 is a breast pump/breast cup assembly 30.

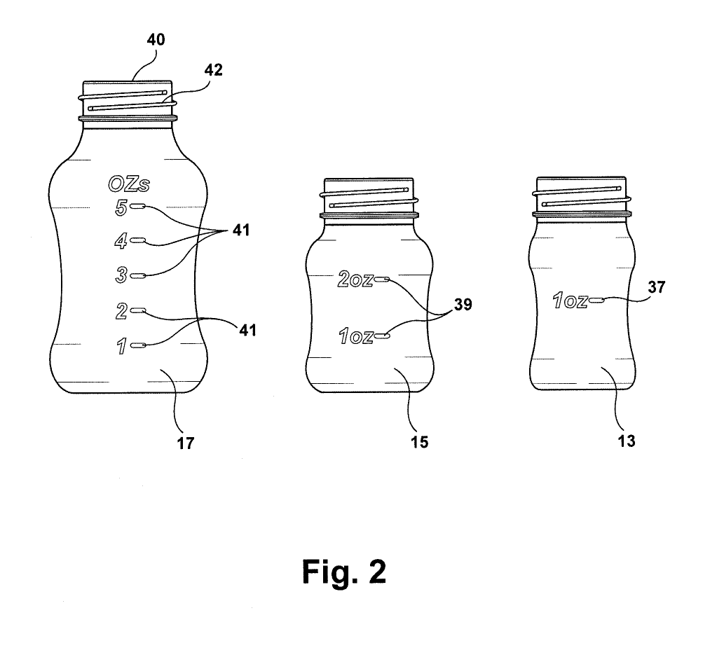

The three differently sized bottles 13, 15, 17 are shown in more detail in FIG. 2. As shown, they each have respective concave sides 31, 33, 35 which, in an illustrative embodiment are circularly contoured at respective radii of 2.5, 1.8 and 1.8 inches. Each bottle is fabricated of a flexible plastic material, e.g. polypropylene or other suitable plastic, and the concave sides facilitate gripping and squeezing of the bottles 13, 15, 17. The 1 and 2 oz. bottles 13, 15 are intended for infant feeding, and the 5 oz. size 17 is intended for breast milk reception and storage; although the 1 and 2 oz. bottles 13, 15 can also be utilized for breast milk reception and storage.

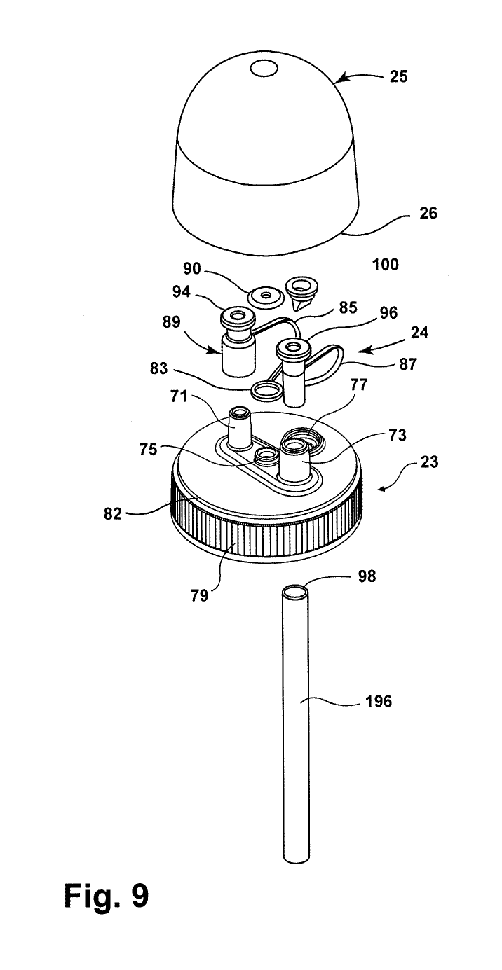

The bottles 13, 15, 17 further include horizontal graduation marks 37, 39, 41 and associated numerical indicia. These graduation marks may be arranged as indicated in FIG. 2, and may include additional graduations in reverse order to facilitate accuracy in delivery of fluids during a gravity/bolus feed. In one embodiment, these graduation marks 37, 39, 41 and indicia are molded into the respective sides of the bottles 13, 15, 17 and indicate how many ounces and/or milliliters of fluid are contained in a respective bottle. Alternatively, these graduation marks may be pad printed on the bottles. In one illustrative embodiment, the two ounce bottle 15 and one ounce bottle 13 have the same height, for example, 2.75 inches, so as to enable them to each function with a “draw” straw 196 (FIG. 9) to be described later. In one illustrative embodiment, the five ounce bottle 17 is 4 inches high. Each bottle 13, 15, 17 further has the same diameter mouth e.g., 40 and the same thread structure, e.g. 42.

In one illustrative embodiment, the solid storage twist cap 19 and open top nipple twist cap 21 may be constructed of suitable plastic material and threaded to mate with any one of the three bottles 13, 15, 17. The dust cover dome cap 25 is constructed of flexible plastic, for example, translucent or clear polypropylene and has a rim 26 shaped and dimensioned to snap on to the top of the caps, e.g. 19, 21, 23 via an interference snap-fit as described further hereafter.

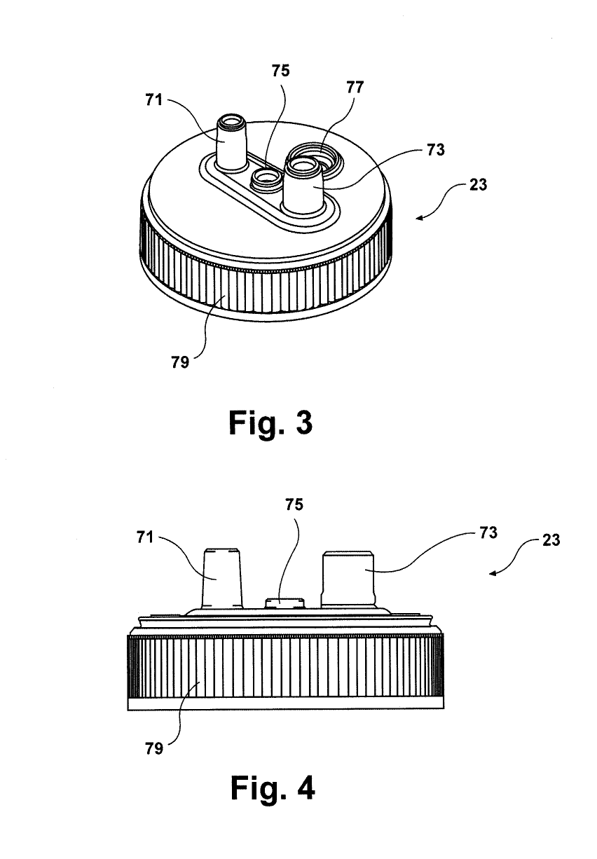

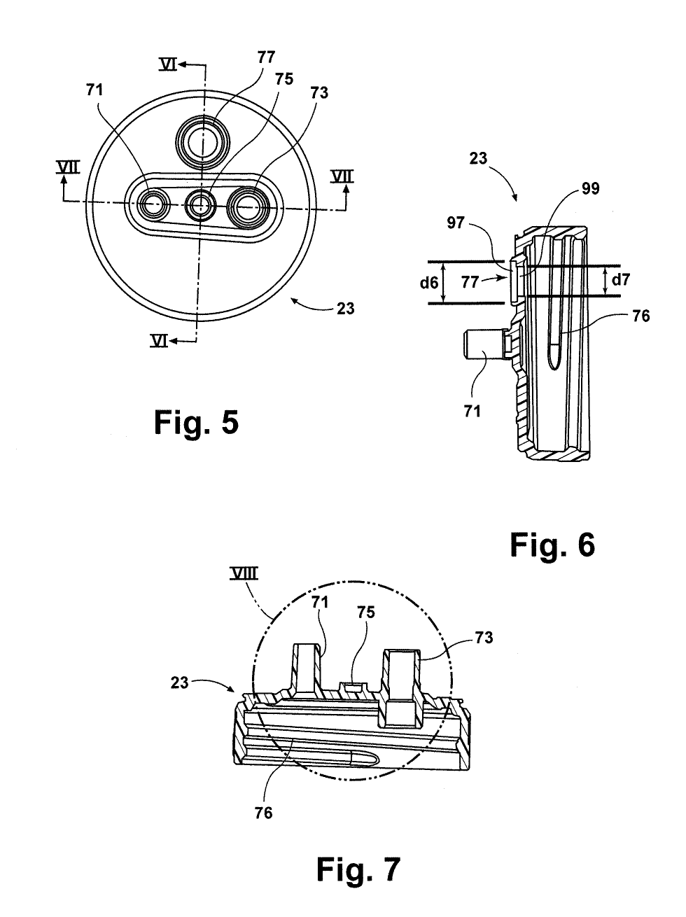

As shown in FIGS. 3-8, the dual ported drip/draw cap 23 is circular in shape and includes a drip port 71, a draw port 73, a well 75, and a vent opening or orifice 77. The side 79 of the cap 23 may be knurled to enhance gripping. The cap 23 additionally has internal threads 76 for mating with the external threads, e.g. 42, of the respective bottles 13, 15, 17. In an illustrative embodiment, such threads 76 may have a pitch of, for example, 0.150. The top surface 80 of the cap 23 has a recessed rim 82 about which the rim 26 of a dust cover cap 25 snap-fits.

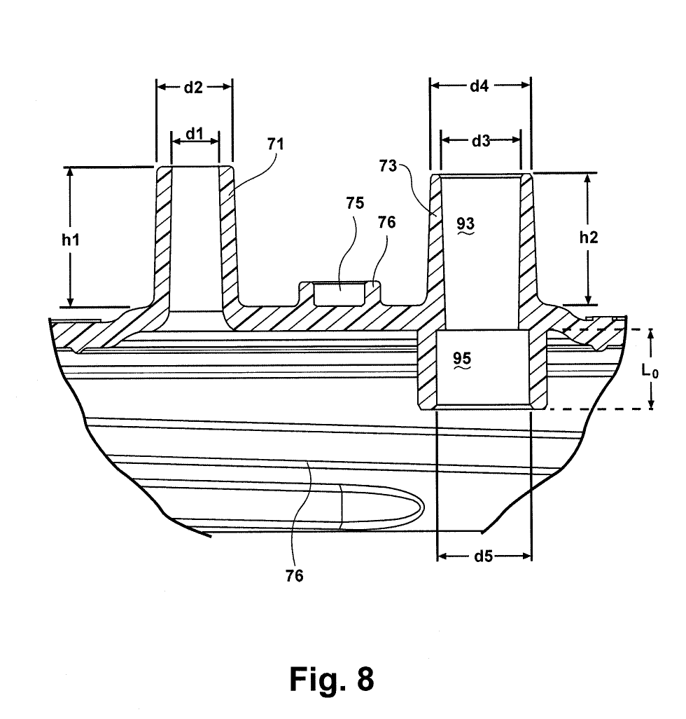

The structure of the drip and draw ports 71, 73 is shown in more detail in FIG. 8. In this illustrative embodiment, the drip port 71 may have a height h₁ of 0.350 inches, an inner diameter d₁ of 0.115 inches and an outer diameter d₂ of 0.186 inches. These diameters d₁, d₂ are selected in order to mate with a standard size enteral feeding tube connector or enteral extension set connector. The draw port 73 may have a height h₂ of 0.327 inches, an inner diameter d₃ of 0.201 inches and an outer diameter d₄ of 0.250 inches in order to allow the insertion of a standard enteral syringe tip. Additionally, the draw port section 93 of inner diameter d₃ opens into a cylindrical inner chamber portion 95 of a diameter d₅ of, for example, 0.225 inches and a length L₀ of 0.200 inches. Such dimensioning accommodates the tip of a standard enteral syringe which is narrower at the distal point where the fluid is ejected. For the draw port 73, the syringe tip will be forced inside the cap 23, and for the drip port 71, the feeding tube connector or extension set connector will be forced over the outside of that port 71. The dimensioning just discussed may of course vary in various embodiments and is provided by way of illustration and not limitation.

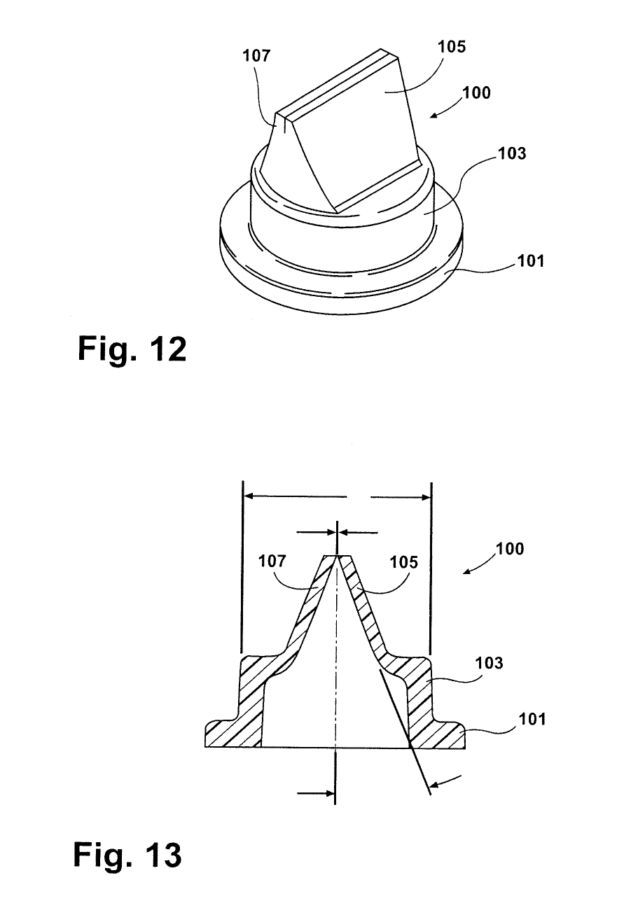

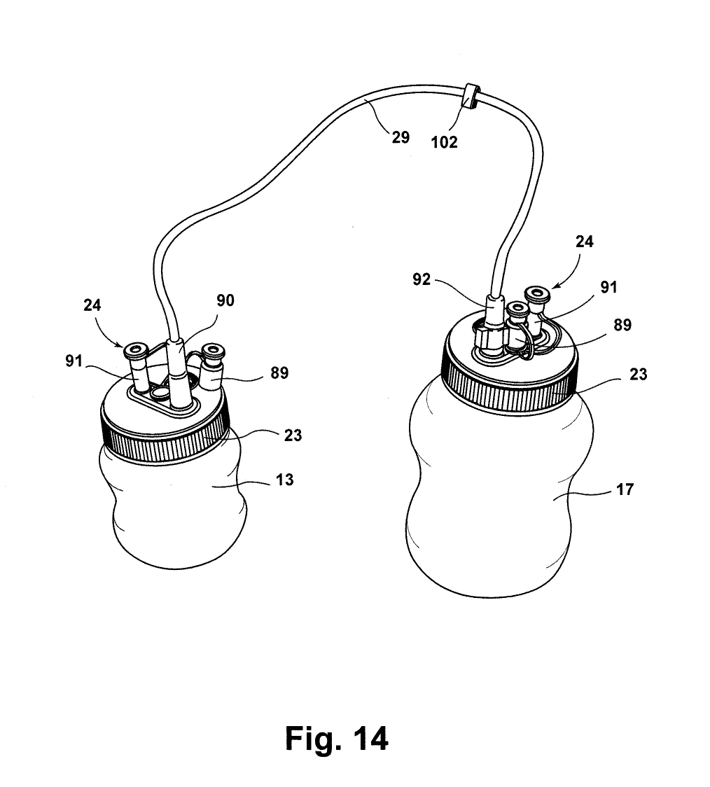

As shown in FIG. 6, the vent receptacle 77 in the cap 23 has a first cylindrical entry portion 97 of a diameter d₆ opening into a cylindrical portion 99 of a second smaller diameter d₇. In an illustrative embodiment, these diameter d₆, d₇ may be, for example, 0.295 and 0.215 inches respectively. These diameters receive a rim 101 and body 103 of a vent 100, shown in more detail in FIGS. 12 and 13. The vent 100 allows displacement of pressure when the draw port 73 is used to withdraw fluid, thereby allowing air to enter to equalize the pressure, and also facilitates use of the drip port 71. Without equalization of pressure, fluid cannot drip out, nor can fluid be withdrawn via a syringe without the syringe plunger seeking to draw back inside the syringe barrel. The vent 100 is always closed until it detects negative pressure inside a bottle. In one embodiment, the vent 100 is made of rubber and is a so-called ‘duckbill valve’. Depending on the size of the vent 100, the lips 105, 107 of the vent 100 will open or ‘crack’ at a pre-determined pressure.

In one embodiment, the female-to-female transfer tube 29 shown in FIG. 1 may be a conventional piece of equipment having female end plugs 90, 92 shaped and dimensioned to sealably fit down and around or “mate” with a respective drip port 71 of a respective dual port caps 23.

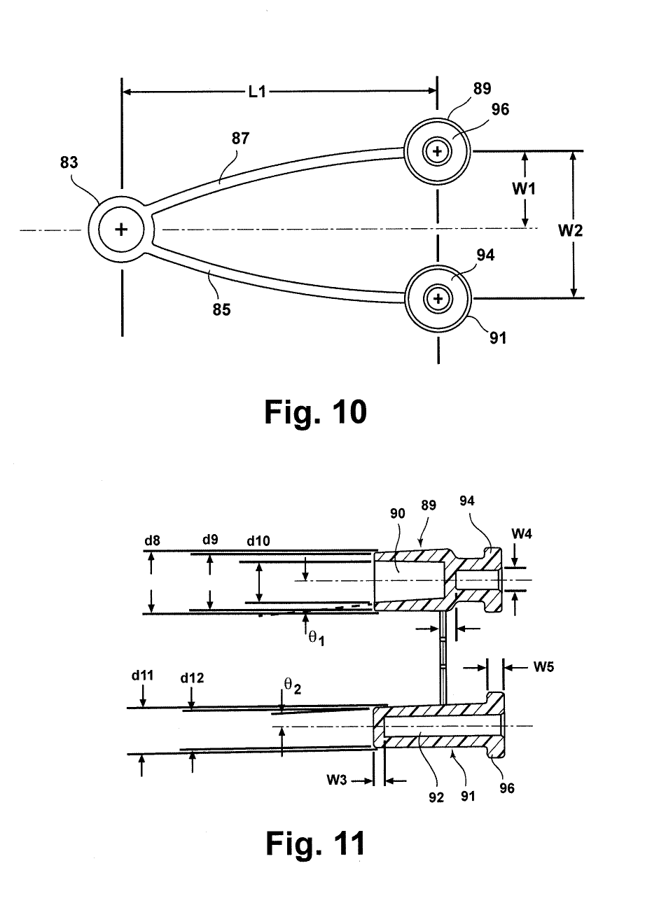

The well 75 in the dual port cap 23 provides an attachment point for a tethered closure plug unit 24. As shown in FIGS. 9-11, the tethered plug closure unit 24 includes a central ring 83 with first and second flexible tether portions or tethers 85, 87 extending therefrom. The first tether portion 85 attaches to a first plug 89, while the second tether portion 87 attaches to a second plug 91. The first plug 89 is shaped and dimensioned to removably close the drip port 71, while the second plug 91 is shaped and dimensioned to removably close the draw port 73. In one embodiment, the first plug 89 may be a female plug having an interior which fits down and around the drip port 71, while the second plug 91 has a male plug portion 92, which fits into and plugs the draw port 73. In another embodiment, the plugs 89, 91 could both be female plugs which are sized to fit down and around the respective drip and draw ports 71, 73. Each plug 89, 91 may further have a cap 94, 96 at respective upper ends thereof to facilitate manipulation of the plugs 89, 91. FIG. 9 further illustrates a cap 90, which snaps into the well 75 after the ring 83 of the tethered plug unit 24 has been fitted around the well rim 76 (FIG. 8) in order to hold the tethered plug unit 24 in place.

The tethered plug unit 24 may be molded of a suitable plastic, for example, polypropylene. Various illustrative dimensions of one embodiment of a tethered plug unit 24 in inches unless noted are:

| | |
|---|---|
| L₁ = 1.5 | ⊖₁ = 1.79° |
| W₁ = .350 | d₁₁ = .208 |
| W₂ = .700 | d₁₂ = .186 |
| d₈ = .303 | ⊖₂ = 1.79° |
| d₉ = .280 | W₃ = .050 |
| d₁₀ = .201 | W₄ = .100 |
| | W₅ = .080 |

Such dimensions of course will vary in various embodiments and are provided by way of illustration and not limitation.

As further shown in FIG. 9, in the illustrative embodiment, a cylindrical straw 196 is provided having an upper rim 98 of a diameter selected to press-fit into the inner chamber portion 95 (FIG. 8) of the draw port 73. The straw 196 is of a length selected to facilitate withdrawal of substantially all, or a selected portion of, the contents of both the 1 and 2 oz. bottles 13, 15 to which a cap 23 is attached. In some embodiments, the straw 196 may be adhesively or otherwise fixed within the inner chamber 95. In other embodiments, the system can be used with or without the straw 196.

In a typical application of the system 11 shown in FIGS. 1-13, the mother of the hospitalized patient will express via a breast pump 30 directly into any of the three available sized bottles 13, 15, 17. As noted above, each bottle is sized to screw directly into a breast cup assembly, e.g. 30 (FIG. 1).

Once the pumping is completed, the mother can then cap the bottle(s) with a solid storage cap 19 or dual port vented cap 23, and refrigerate or freeze the bottle. Optionally, she can also snap on a dust cover dome cap 25 for added safety. The mother will also mark the bottle(s) with name, and date/time that the milk was expressed on supplied adhesive labels(s).

Upon arrival of the breast milk at a hospital, a clinical staff member will place the bottles, e.g. 13, 15, 17, into their storage area. When it is time for the patient to be fed, a member of the clinical staff will prepare the milk for feeding.

In a first illustrative feeding scenario illustrated in FIG. 14, the nurse has a 5 oz. bottle 17 of milk and must fortify 1 oz. of milk to feed to the patient. If the bottles 17 arrived with a solid cap 19, the nurse will apply a dual port “drip/draw” cap 23 to both the supply and feedings bottles 17, 13. The nurse will place fortifier in the 1 oz. feeding bottle 13 prior to applying the dual port cap 23.

The nurse will then remove the plugs 89 from the drip ports 71 of each cap 23, and additionally may remove plug 91 from the cap of the receiving bottle if increased speed of fluid transfer is desired. Then, the transfer tube 29 is attached to the drip port 71 of each dual port cap 23 as shown in FIG. 14 and 1 oz. of milk is transferred from the 5 oz. bottle 17 to the 1 oz. bottle 13 by simply inverting the larger bottle 17 in the air above the smaller bottle 13. In one embodiment, the transfer tube 29 also incorporates a ‘pinch clamp’ 102 or other device that will allow the user to stop the transfer of fluid in a precise manner. The tethered closure plugs 89 and optionally the plug 91 on the receiving bottle's cap are then re-applied to the drip ports 71 of both bottles 13, 17, respectively. The 5 oz. bottle 17 will then be placed back into storage.

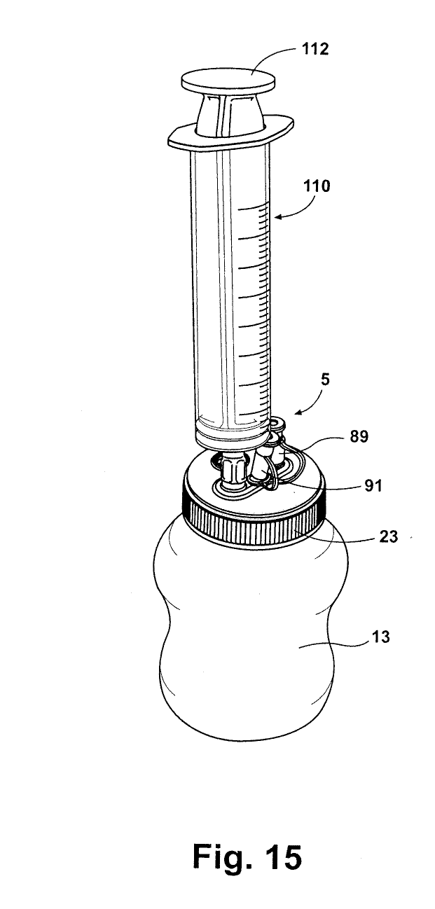

At this point, the nurse can choose either to attempt a nipple feed by utilizing a nipple 20 and the open top nipple cap 21, or opt to go directly to a pump or gravity/bolus feeding. If the nurse opts for pump feeding, the nurse will utilize the “draw” port 73 of the cap 23 by inserting a standard enteral type syringe 110 into that draw port 73, as shown in FIG. 15, and then withdraw the plunger 112 to extract the desired amount of milk. The milk is now ready to be placed in a feeding pump to complete the feeding process.

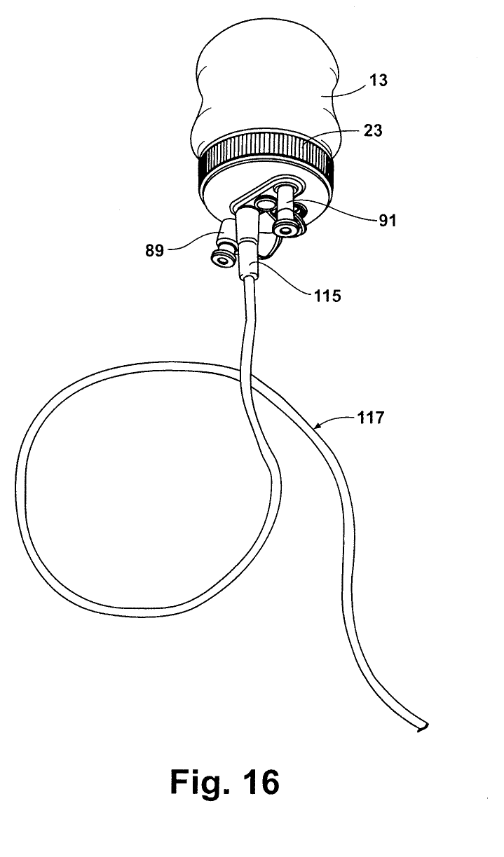

A second illustrative feeding scenario is a gravity/bolus feeding method. In this scenario, the nurse will apply the same steps as described in the first scenario above in order to place 1 (one) oz. of fortified milk into a 1 oz. bottle 13. As illustrated in FIG. 16, the nurse then utilizes the “drip” port 71 of the dual port cap 23 and attaches the female connector 115 of a feeding tube or extension set tube connector 117 to the drip port 71. The nurse is now ready to begin the gravity/bolus feeding process. In this feeding process, the cap 23 is vented via vent 100 to allow the feeding fluid to begin to flow by simple gravity. If the flow does not begin on its own, due, for example, to overly viscous fluid and/or small bore tubing, the nurse can gently ‘squeeze’ the bottle 13 to initiate adequate flow.

A breast milk collection, feeding, and storage system according to illustrative embodiments exhibits advantages including, but not limited to, reducing or eliminating numerous sources of air borne contamination, reducing or preventing infection, and reducing or eliminating spillage. Once attached, the dual ported caps need not be removed and the closed aspects of the system contribute to such advantages. The system provides simplification of overall apparatus and procedure, saving of time, and reduces the number of accessories required. The graduations on the bottles are further designed to assist the nurse/clinician. Various embodiments provide improvements throughout the process of breast milk collection, storage, transfer, mixing, and the multiple methods of feeding.

Those skilled in the art will appreciate that various adaptations and modifications of the just described illustrative embodiments can be configured without departing from the scope and spirit of the invention. Therefore, it is to be understood that, within the scope of the appended claims, the invention may be practiced other than as specifically described herein.

What is claimed:

1. Breast milk storage and feeding apparatus comprising:
first, second and third differently sized bottles, each having a mouth portion of the same diameter and a common external thread structure on each respective mouth portion; and
first and second dual port caps each sized and threaded to threadably attach to each of said first, second and third differently sized bottles, each dual port cap having a drip port and a draw port, each drip port and each draw port comprising an upwardly extending projection having an internal channel therein extending through the respective cap, the first and second caps each further having a pressure relief vent formed therein; and
first and second tethered closure plug units, each attached to a respective one of the first and second dual port caps, each tethered closure plug unit further having first and second tethered plugs shaped and dimensioned to plug or close a respective one of said drip or draw ports.

2. The apparatus of claim 1 further comprising a fluid transfer tube having first and second connector plugs at respective ends thereof, each connector plug being sized to sealably attach to a respective drip port of each the first and second dual port caps.

3. A method for preparing and feeding breast milk employing apparatus comprising:
first and second differently sized bottles, each having a mouth portion of the same diameter and a common external thread structure on each respective mouth portion;
first and second dual port caps each sized and threaded to threadably attach to each of said first and second differently sized bottles, each dual port cap having a drip port and a draw port, each drip port and each draw port comprising an upwardly extending projection having an internal channel therein extending through the respective cap, the first and second caps each further having a well and a vent formed therein; and
first and second tethered closure plug units each attached to the respective well of a respective one of the first and second dual port caps, each plug unit further having first and second tethered plugs shaped and dimensioned to plug or a respective one of said drip or draw ports,
the method comprising:
filling the first bottle with breast milk;
placing fortifier in the second bottle;
applying a first dual port cap to the first bottle and a second dual port cap to the second bottle;
transferring a selected amount of milk from the first bottle to the second bottle by attaching a transfer tube between the drip ports of said first and second bottles and inverting the first bottle; and
feeding a patient by applying a nipple to said second bottle and directly feeding the patient.

4. A method for preparing and feeding breast milk employing apparatus comprising:
first and second differently sized bottles, each having a mouth portion of the same diameter and a common external thread structure on each mouth portion;
first and second dual port caps each sized and threaded to threadably attach to each of said first and second differently sized bottles, each dual port cap having a drip port and a draw port, each drip port and each draw port comprising an upwardly extending projection having an internal channel therein extending through the respective cap, the first and second caps each further having a well and a vent formed therein; and
first and second tethered closure plug units each attached to a respective well of a respective one of the first and second dual port caps, each tethered plug unit further having first and second tethered plugs shaped and dimensioned to plug or close a respective one of said drip or draw ports,
the method comprising:
filling the first bottle with breast milk;
placing fortifier in the second bottle;
applying a first dual port cap to the first bottle and a second dual port cap to the second bottle;
transferring a selected amount of milk from the first bottle to the second bottle by attaching a transfer tube between the drip ports of said first and second dual port bottles and inverting the first bottle; and
feeding a patient by utilizing the drip port of the second dual port bottle in a gravity/bolus feeding process.

5. Breast milk feeding apparatus comprising:
first and second dual port caps each sized and threaded to threadably attach to either one of first and second differently sized bottles;
a drip port and a draw port formed on each dual port cap, each drip port and each draw port comprising an upwardly extending projection having an internal channel therein extending through the respective cap, the drip port being shaped and dimensioned to mate with a standard sized enteral feeding tube connector enteral extension set connector, the draw port being shaped and being dimensioned to enable insertion of a standard enteral syringe;
a straw inserted into an interior portion of said draw port; and
and a vent formed in each of said first and second dual port caps.

6. The apparatus of claim 5 further comprising first and second tethered closure plug units, each attached to the respective well of a respective one of the first and second caps, each further having first and second tethered plugs shaped and dimensioned to plug a respective one of said drip or draw ports.

7. Breast milk feeding apparatus comprising:
first and second dual port caps each sized and threaded to threadably attach to either one of first and second differently sized bottles;
a drip port and a draw port formed on each dual port cap, each drip port and each draw port comprising an upwardly extending projection having an internal channel therein extending through the respective cap, the drip port being shaped and dimensioned to mate with a standard sized enteral feeding tube connector or enteral extension set connector, the draw port being shaped and being dimensioned to enable insertion of a standard enteral syringe;
a straw inserted into an interior portion of said draw port; and
a vent formed in each of said first and second dual port caps.

8. The apparatus of claim 1 further comprising volume indicating graduation marks on each bottle.

9. The apparatus of claim 7 wherein each dual port cap has a rim and further comprising a dust cap shaped to snap-fit into each said rim.

10. The apparatus of claim 1 further comprising a nipple cap.

11. The apparatus of claim 7 wherein each vent is a duck bill vent.

12. The apparatus of claim 1 wherein the first tethered plug is female fits down and around drip port and the second tethered closure plug is male fitting into and plugging the draw port.

13. The apparatus of claim 1 wherein the drip port is shaped and dimensioned to mate with a standard sized enteral feeding tube connector or enteral extension set connector and the draw port is shaped and dimensioned to enable insertion of a standard enteral syringe.

14. The method of claim 3 wherein instead of directly feeding the patient, the patient is fed by inserting a syringe into the draw port of the second bottle and thereafter employing the syringe to feed the patient.
